(19) United States
(12) Patent Application Publication
(10) Pub. No.: US 2007/0127070 A1
(43) Pub. Date: Jun. 7, 2007

(54) Image forming apparatus

(75) Inventor: Toshihiko Murakami, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/295,846

(22) Filed: Dec. 7, 2005

(51) Int. Cl. G06K 15/00

(52) U.S. Cl. 358/1.16

(57) ABSTRACT

An image forming apparatus includes a main controller for controlling the operation of the entire apparatus, an operating section for setting print jobs, a scanner for reading a document, and a printer for printing print data. The main controller includes an HDD serving as a storage device and a main CPU serving as a data processing section. The HDD includes a data-storage region divided into multiple subregions for storing print data and a file-management region for storing file-management information on the print data stored in the data-storage region. The main CPU divides the print data to be stored in the HDD into multiple data units, stores the multiple data units into multiple subregions of the HDD in a distributed manner, stores the file-management information on the multiple data units into the file-management region, and erases the file-management information stored in the file-management region after completion of the print jobs.

### BACKGROUND OF THE INVENTION

1. Field of the Invention

The present invention relates to an image forming apparatus such as copiers, printers, fax machines, and digital multifunctional peripherals having some of those functions, and in particular, it relates to an image forming apparatus having a security function for preventing the leakage of print data.

2. Description of the Related Art

For example, in the case of digital multifunction machines, when a document is scanned by a scanner, its reflected light is read by photoelectric elements such as CCDs. The output from the photoelectric elements is translated to page data by an image processor, and the page data is printed. The page data is appropriately compressed, and stored in a hard disk drive (HDD) that is one type of storage device. This process allows a printing operation that has been interrupted because of a problem such as paper jam to be restarted using the data stored in the HDD without the need for scanning the document again after the trouble has been solved. This process also facilitates print jobs such as sorting, multi-copy printing, and double-sided printing. After the print jobs have completed, the page data stored in the HDD is manipulated to block access to the page data used in the print jobs for reconstituting it.

A printing process by a printer, and a receive-data printing process and a data-transmission process by a facsimile are also performed in the same way. For example, in the case of printing by a printer, print data described in page description language is transmitted from a personal computer or the like to a printer. The print data is translated to page data by bitmap conversion on a per-page basis by a raster image processor (RIP) mounted to the printer. The page data is printed, and stored in an HDD, and after the print jobs have completed, the page data in the HDD is manipulated so as to block access to the page data used in the print jobs, as in the above-described process by digital copiers.

In general, HDDs have a data-storage region and a file-management region. In image forming apparatuses, the data-storage region stores image information, that is, page data itself. The file-management region stores file-management information, that is, information on which page data is stored in which part of the data-storage region.

Thus, for the HDD-data manipulation after completion of the print jobs, specifically speaking, information on the presence of page data to be accessed is erased from the file-management region. With such a data manipulation, the page data stored in the HDD remains as it is, but its location cannot be detected, so that the page data becomes inaccessible. As a result, the page data can be regarded as having been erased. Such a data manipulation method has the advantage of reducing the load on the processor that performs controls and processes in the image forming apparatuses.

However, in this data manipulation method, the page data itself, which is image data and also print data, is not erased. It is therefore not impossible to reconstitute files (documents, charts, etc.) corresponding to the page data stored in the HDD. Accordingly, if a malicious third party obtains an HDD in which highly-confidential important data is stored, the data may be reconstituted, so that the information may be stolen. Particularly when the third party is familiar with the algorism for data compression and decompression, the probability of reconstitution of files becomes high.

A well-known method for solving the problems to improve the security of data stored in an HDD is a method in which page data is encrypted using a special cipher machine when written to the HDD. However, this method has the disadvantage of requiring the cipher machine, thus increasing production cost. Also, it has the disadvantage of taking much time for encryption decreasing the speed of forming images, thus degrading print performance.

Another known method is a method of completely erasing the data stored in an HDD by overwriting random data on the data multiple times. However, this method needs long time to erase the data. Also, scanning of new documents and print jobs are limited while the data is erased, so that print performance is degraded. Furthermore, the number of accesses to the HDD is increased, resulting in a decrease in the life of the HDD.

### SUMMARY OF THE INVENTION

The invention has been made in view of the above problems. Accordingly, it is an object of the invention to provide an image forming apparatus in which the security function for data stored in a storage device is improved with a simple sequence and without a decrease in print performance.

According to a first aspect of the invention, an image forming apparatus is provided that includes a storage device having a data-storage region divided into multiple subregions for storing print data, and a file-management region for storing file-management information on the print data stored in the data-storage region, and a data processing section that divides the print data to be stored in the storage device into multiple data units, stores the multiple data units into multiple subregions in a distributed manner, stores the file-management information on the multiple data units into the file-management region, and erases the file-management information stored in the file-management region after completion of print jobs.

Preferably, the data processing section compresses the data size of the print data to be stored in the storage device, and divides the compressed data into multiple data units. This structure can lighten the load on the storage device and reduce access time. Preferably, the storage device is a hard disk drive. In that case, it is preferable that the size of the data unit be equal to or larger than a sector that is the physical storage unit of the storage device and equal to or smaller than a cluster that is the logical storage unit of data. The division of print data to the minimum can make it difficult to reconstitute the print data. Preferably, the data processing section sets a data storage sequence for the multiple subregions, and repeatedly assigns the multiple data units to the multiple subregions in accordance with the data storage sequence. This structure can make it difficult to reconstitute the print data after the file-management information is erased. Alternatively, the data processing section may change the sequence of storing the multiple data units into the multiple subregions, depending on the number of the subregions. In this case, the reconstitution of print data can be made more difficult.

When the print data includes multiple items of page data, it is preferable that the data processing section divides the print data into multiple data units for each item of page data. Also in this case, the data processing section may set a data storage sequence for the multiple subregions, and repeatedly assign the multiple data units to the multiple subregions in accordance with the data storage sequence. Alternatively, the data processing section may change the data storage sequence from one page data to another, or change the data storage sequence, depending on the number of the subregions.

Preferably, the image forming apparatus according to an embodiment of the invention includes a plurality of the storage devices; wherein the data processing section may store the multiple data units into the multiple subregions of the plurality of storage devices in a distributed manner. This structure can make it difficult to reconstitute the print data.

According to a second aspect of the invention, an image forming apparatus is provided that includes a scanner for reading the image of a document, an image processing section for converting the image data read by the scanner to page data and storing the page data, and a printer for printing the print data output from the image processing section on a specified medium. The image processing section includes a storage device having a data-storage region divided into multiple subregions for storing the page data, and a file-management region for storing file-management information on the page data stored in the data-storage region, and a data processing section that divides the page data to be stored in the storage device into multiple data units, stores the multiple data units into multiple subregions in a distributed manner, stores the file-management information on the multiple data units in the file-management region, and erases the file-management information stored in the file-management region after completion of print jobs.

The image forming apparatus may further include a network interface for capturing print data from the exterior. In this case, the image processing section processes the print data captured from the exterior in the same way as the image data read by the scanner. The image forming apparatus may further include: a communication interface for performing facsimile communication with the exterior. Also in this case, the image processing section processes the receive data in the same way as the image data read by the scanner. For facsimile transmission, the print data stored in the storage device is transmitted to the exterior via the communication interface.

According to the invention, print data is divided into multiple data units, and stored in the storage device in a distributed manner. Therefore, when its file-management information is erased, the reconstitution of the print data becomes extremely difficult. Thus the security of print data can be improved. Also, the distributed storage of data units into a storage device lightens the load on the storage device, so that print performance is not degraded.

### BRIEF DESCRIPTION OF THE DRAWINGS

FIG. 1 is a diagram of the system configuration of an image forming apparatus according to an embodiment of the invention;

FIG. 2 is a diagram of an example of a print-data storage region of an HDD which is divided into multiple subregions;

FIG. 3 is a flowchart of a form of data processing performed by the image forming apparatus;

FIG. 4 is a diagram of an example of page data to be stored in the HDD;

FIG. 5 is a diagram of an example of an algorithm for assigning divided page data (data units) to multiple subregions;

FIG. 6 is a diagram of another example of the algorithm for assigning data units to multiple subregions;

FIG. 7 is a diagram of further another example of the algorithm for assigning data units to multiple subregions;

FIG. 8 is a diagram of the system configuration of an image forming apparatus according to another embodiment of the invention;

FIG. 9 is a diagram of an example of the print-data storage regions of two HDDs which are each divided into multiple subregions; and

FIG. 10 is a diagram of an example of assignment of data units to the subregions of the two HDDs.

### DESCRIPTION OF THE PREFERRED EMBODIMENT

Embodiments of the invention will be specifically described with reference to the drawings.

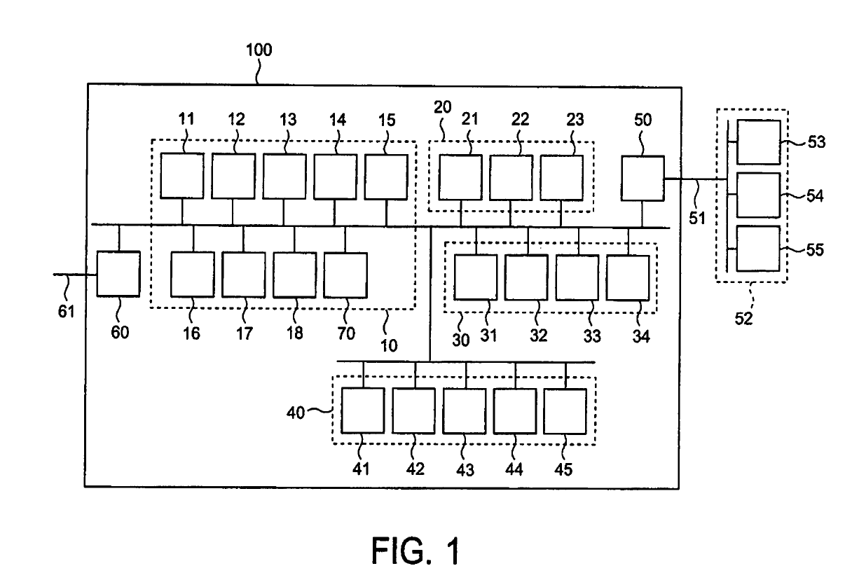

FIG. 1 shows the system configuration of an image forming apparatus according to an embodiment of the invention. The image forming apparatus 100 includes a main controller 10 serving as a data processing section that controls the operation of the entire apparatus, an operating section 20 for users to set print jobs and other jobs, a scanner unit 30 for reading a document, and a print unit 40 for printing print data.

The image forming apparatus 100 further includes a network interface 50 and a communication interface 60. To the network interface 50 are connected an external unit 52 for providing print data to the image forming apparatus 100 via a network 51 and other image forming apparatuses (not shown). The communication interface 60 is used, for example, to transfer facsimile data via a telephone line 61.

For example, the image forming apparatus 100 is a digital multifunctional peripheral (MFP) device; the external unit 52 is a client PC; and the network 51 is a LAN.

The main controller 10 includes a main CPU 11, a ROM 12, a RAM 13, an NVRAM 14, a shared RAM 15, an image processor 16, a page-memory controller 17, a page memory 18, and a hard disk drive (HDD) 70 serving as a storage device.

The main CPU 11 controls the entire apparatus; processes image data, page data, and print data, which are used by the entire apparatus. The ROM 12 stores various control programs necessary for controlling the operation of the image forming apparatus 100 and for data processing. The RAM 13 temporarily stores the control programs and data. The NVRAM 14 can store memory data even if power is shut off. The shared RAM 15 is used for bidirectional communication between the main CPU 11 and a printer CPU 41 of the print unit 40.

The page memory 18 stores page data. The page data is data in which image data read by the scanner unit 30 or image data (e.g., document data and drawing-image data) from the external unit 52 is translated into a bitmap format. The page data is generally compressed to be reduced in data size before being stored in the page memory 18. The compressed page data is hereinafter referred to as compressed page data. The page memory 18 has a region capable of storing compressed page data of multiple pages. The page-memory controller 17 writes or reads compressed page data to/from the page memory 18 every page.

The HDD 70 temporarily stores compressed page data as print data. The HDD 70 includes a print-data storage region, a file-management-information storage region for storing information on managing the file of stored print data, and other regions.

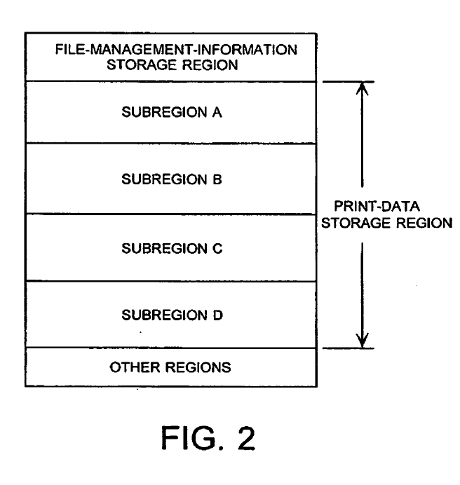

The print-data storage region is divided into multiple subregions. FIG. 2 shows an example of the print-data storage region of the HDD 70 which is divided into multiple subregions. In this example, the print-data storage region is divided into four subregions A to D. The memory capacities of the subregions A to D may be equal to or different from one another. The number of the subregions is not limited to four. The division of the print-data storage region into multiple subregions may be made through addressing of sections (areas) or, alternatively, through the division of the memory capacity into partitions. The storage and erasure of print data to/from the HDD 70 will be specifically described later.

The operating section 20 includes a panel CPU 21 connected to the main CPU 11, an operating key 22, and a display 23 made of liquid crystal or the like. The panel CPU 21 controls the setting of print jobs and so on. The operating key 22 is used for operations such as setting, performance, and termination of print jobs. More specifically, the operating key 22 is used to input various instructions such as the number or print copies, print size, one-sided printing, double-sided printing, sorting, and start/stop of the reading of a document. The display 23 displays the conditions of setting and the state of progress of the print jobs. The use of the display 23 having a touch panel function provides the display 23 with the function of the operating key 22.

The scanner unit 30 irradiates a document placed on a document glass with an exposure lamp, reads its reflected light with CCDs, and converts it to image data. The scanner unit 30 includes a scanner CPU 31 that controls the operation of the scanner unit 30; a CCD driver 32 that drives a color-image sensor (not shown); a scan-motor driver 33 that controls the rotation of a scan motor (not shown); and an image correcting section 34. The scanner unit 30 includes a ROM (not shown) in which a scanner control program and so forth are stored and a RAM (not shown) for use in storing data.

Principal components of the image correcting section 34 are an A/D converter circuit that converts RGB analog signals output from the color-image sensor to digital signals; a shading correction circuit that corrects fluctuations in threshold level relative to the output signals due to variations of the color-image sensor; and a line memory that temporarily stores the corrected digital signals from the shading correction circuit.

The print unit 40 includes a printer CPU 41 that controls the operation of the print unit 40; a laser driver 42 that drives a laser; a feed controller 43 that controls paper feeding; a controller 44 for electrical charging, developing, and transfer; and a RAM 45 for temporarily storing print data. The print unit 40 further includes a ROM (not shown) in which programs for controlling various operations of the print unit 40 are stored.

The external unit 52 includes a data generating section 53 that creates print data such as sentences and figures using application software; a printer driver 54 that converts the image data from the data generating section 53 to page-description-language data (PDL data) and outputs it to the image forming apparatus 100 via the network 51; and an instructing section 55 that gives the image forming apparatus 100 a print request and so on.

As is apparent from the above-described structure, the control system of the image forming apparatus 100 includes multiple CPUs: the main CPU 11 of the main controller 10; the panel CPU 21 of the operating section 20; the scanner CPU 31 of the scanner unit 30; and the printer CPU 41 of the print unit 40. The main CPU 11 performs bidirectional communication with the printer CPU 41 via the shared RAM 15. The main CPU 11 issues an operation instruction, and the printer CPU 41 returns the operating status. The printer CPU 41 and the scanner CPU 31 perform serial communication.

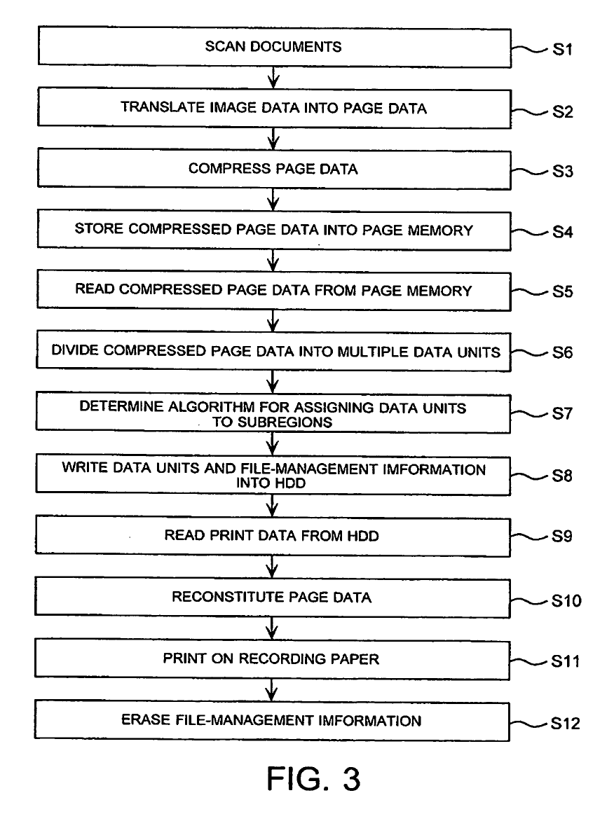

The data processing by the image forming apparatus 100 will then be described. FIG. 3 is a flowchart illustrating an embodiment of data processing performed by the image forming apparatus 100. The print jobs of reading multiple documents and printing multiple copies are herein set as the data processing.

When documents are placed on the scanner unit 30, and print jobs are specified from the operating key 22, the scanner unit 30 starts scanning of the documents (S1). The image data read by the scanner unit 30 is sent to the main controller 10 one by one, where it is translated to page data (S2).

When the page data is created, it is sent to the print unit 40, where printing can be started. Accordingly, the image forming apparatus 100 can adopt a structure in which the created page data is stored in the RAM 45 of the print unit 40 in sequence, and then the page data stored in the RAM 45 is retrieved from the RAM 45 and printed in sequence when the print unit 40 comes to a printable state.

However, to simplify the data processing flow, after the page data has been created, the compression of the page data, division into data units, storage of the data units into the HDD 70, reading of the data units from the HDD 70, reconstitution of the page data, printing process, the erasure of the print data from the HDD 70 are performed in sequence. This data processing flow will be described hereinbelow.

The created page data is compressed to a small data size in sequence in accordance with a data compression program stored in the ROM 12 (S3). The page data is large in size. Thus, when it is stored in the HDD 70 without being compressed, the operation time of the HDD 70 will be increased. Accordingly, the compression of page data enhances the printing performance of the image forming apparatus 100, and eliminates the need for increasing the capacity of the HDD 70. Furthermore, since the time to access the HDD 70 can be reduced, the life of the HDD 70 can be increased.

The compressed page data is stored in the page memory 18 in sequence by the page-memory controller 17 (S4). The compressed page data stored in the page memory 18 is read by the main controller 10 in order from the first page to be stored in the HDD 70 (S5). The read compressed page data is divided into multiple data units every page data before it is stored in the HDD 70 (S6).

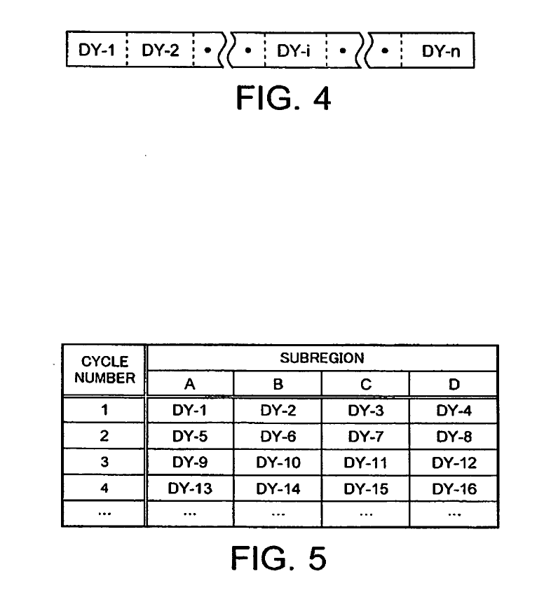

FIG. 4 schematically illustrates compressed page data to be stored in the HDD 70 which is divided into multiple data units. Here compressed page data 90 is divided into n (n≧2) data units (DY-1, DY-2, - - - , DY-i, - - - , DY-n). The file sizes of the data units (DY-i) do not necessarily need to be equal. It is preferable that the file size of the data unit (DY-i) be equal to or larger than a sector that is the physical storage unit of the HDD and equal to or smaller than a cluster that is the logical storage unit of data. The cluster is the minimum unit for treating files by the HDD. Accordingly the division of the compressed page data 90 into small sized data units can make it difficult to reconstitute the print data stored in the HDD 70.

As has been described with reference to FIG. 2, the print-data storage region of the HDD 70 is divided into four subregions A to D. Accordingly, an algorithm for assigning the created data units (DY-i) to any of the subregions A to D is determined (S7). The determination of the assignment algorithm must not necessarily be made after step S6, but may be made at any timing before step S6.

FIG. 5 illustrates an example of the algorithm for assigning the data units (DY-i) to the subregions A to D. In FIG. 5, the number n of the data units (DY-i) is set at 16, and the data storage sequence of one cycle of the subregions A to D is A, B, C, and D. The assignment algorithm shown in FIG. 5 assigns the multiple data units (DY-i) to the subregions A to D repeatedly in the order of the subregions A, B, C, and D. In other words, one data unit is assigned to each of the subregions A to D in one cycle. Data is stored in the order of the subregions A, B, C, and D. Accordingly, in the first cycle, a data unit (DY-1) is assigned to the subregion A; a data unit (DY-2) is assigned to the subregion B; a data unit (DY-3) is assigned to the subregion C; and a data unit (DY-4) is assigned to the subregion D, respectively. Hereinafter, in the second cycle, data units (DY-5), (DY-6), (DY-7), and (DY-8) are similarly assigned to the subregions A, B, C, and D, respectively, and in the third cycle or later, similar assignment is performed.

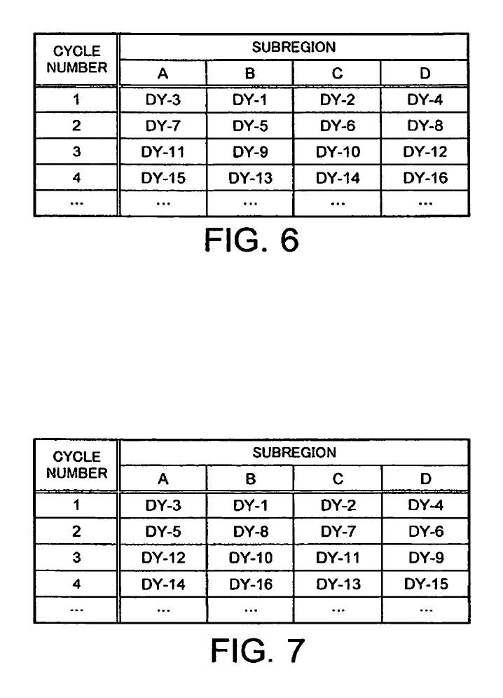

FIG. 6 illustrates another example of the algorithm for assigning the data units (DY-i) to the subregions A to D. The assignment algorithm shown in FIG. 6 determines the data storage sequence of one cycle of the subregions A to D to be B, C, A, and D, and so assigns the multiple data units (DY-i) to the subregions A to D repeatedly in the order of the subregions B, C, A, and D. Accordingly, in the first cycle, a data unit (DY-1) is assigned to the subregion B; a data unit (DY-2) is assigned to the subregion C; a data unit (DY-3) is assigned to the subregion A; and a data unit (DY-4) is assigned to the subregion D, respectively. Hereinafter, the similar assignment is performed.

The assignment algorithms shown in FIGS. 5 and 6 determine the data storage sequence of one cycle of the subregions A to D, and assign data to the subregions A to D in each cycle in the same order. Accordingly, there are 24 combinations of data storage sequences for the subregions A to D. FIGS. 5 and 6 show two of the combinations.

FIG. 7 illustrates another example of the algorithm for assigning the data units (DY-i) to the subregions A to D. In the assignment algorithm shown in FIG. 7, the data storage sequence of the subregions A to D is varied from one cycle to another. Here the storage sequence of the data units (DY-1) in the first cycle is the sequence of the subregions B, C, A, and D; in the second cycle, it is the sequence of the subregions A, D, C, and B; in the third cycle, it is the sequence of D, B, C, and A; and in the fourth cycle, it is the sequence of the subregions C, A, D, and B. Cycles in which the data storage sequences of the subregions A to D are the same may continue. The use of the assignment algorithms can make it more difficult to reconstitute print data.

File-management information includes page-data-identification information, information on the addresses and sequences of the data units (DY-i) stored in the HDD 70, and other information. The data units (DY-i) which are print data are stored in the print-data storage region of the HDD 70 according to the determined assignment algorithm, while the file-management information is stored in the file-management-information storage region of the HDD 70 (S8). In storing the data units (DY-i), for example, the same assignment algorithm may always be used or, alternatively, different assignment algorithms may be used from one print job to another.

The print data stored in the HDD 70 is read from the HDD 70 to be printed on paper in accordance with the file-management information (S9). The print data read from the HDD 70 is reconstituted to page data (S10). The reconstituted page data is stored in the RAM 45 of the print unit 40 in the sequence of printing. The processes of steps S9 and S10 are performed while the free spaces of, e.g., the RAM 13, the NVRAM 14, and the RAM 45 are monitored. When the print unit 40 comes to a mechanically printable state, the page data stored in the RAM 45 is read from the RAM 45 and printed on paper (S11).

After the print jobs have completed, the file-management information on the print data used for the completed print jobs is erased from the HDD 70 (S12). After the completion of the process of step S12, the print data itself remains physically in the HDD 70. However, when the file-management information indicative of the presence of the print data is erased, access to the print data becomes difficult. Moreover, the print data has been divided into data units and stored in a distributed manner according to a specified assignment algorithm. Therefore, when the file-management information is erased, it becomes extremely difficult to reconstitute the print data as page data, images, or files. Thus, after the process of step S12 has been performed, the print data is regarded as being erased.

The above-described manipulation of the page data can increase the security of the print data stored in the HDD 70. The distributed storage of the data units does not increase the load on the hard disk drive, thus preventing the degradation of printing performance.

It is to be understood that the above-described various data processings and mechanical processings are performed in parallel according to the capacities of the CPUs and memories implemented in the image forming apparatus 100. Specifically, while the scanner unit 30 is scanning a document, the printing by the print unit 40, the writing of the data units (DY-i) to the HDD 70, the reading of print data from the HDD 70, the processing of page data, data communication in the image forming apparatus 100 and so forth are performed in parallel.

It is also to be understood that some of the data processings are not performed, depending on the details of the print jobs. For example, there may be a case where a print job is specified in which the number of documents is small and the number of copies is also small. In this case, page data is directly sent to the print unit 40, wherein when printing process is completed without troubles, the print data stored in the HDD 70 is erased without being read for printing.

It goes without saying that the above-described method for storing print data into the HDD 70 can also be used to store print data sent from the external unit 52 and to store facsimile transmit data and facsimile receive data.

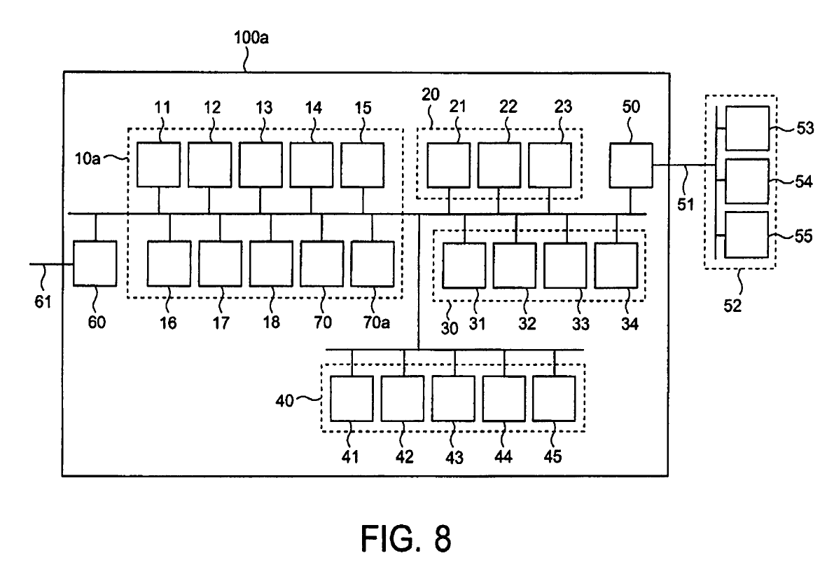

FIG. 8 illustrates the system configuration of an image forming apparatus according to another embodiment of the invention. The image forming apparatus 100a has the same structure as that of the image forming apparatus 100 shown in FIG. 1 except that its main controller 10a includes two HDDs 70 and 70a for storing print data.

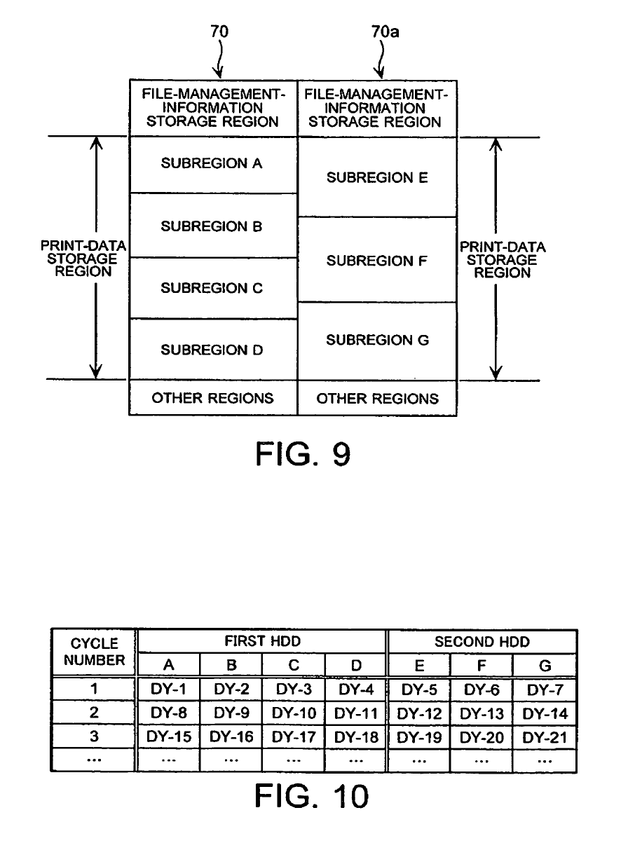

FIG. 9 shows an example of the print-data storage regions of the two HDDs 70 and 70a which are each divided into multiple data units. The subregion setting for the print-data storage region of the HDD 70 is the same as the example of FIG. 2. For the HDD 70a, the print-data storage region is divided into three subregions E to G. Thus, there is no need to set the same number of subregions for the HDDs.

FIG. 10 illustrates an example of assignment of data units to multiple subregions set in the print-data storage regions of the two HDDs 70 and 70a. Here is shown an example in which compressed page data is divided into 21 data units. The assignment algorithm used herein assigns the data storage sequence of one cycle in the HDD 70 in the order of subregions A, B, C, and D, and the data storage sequence of one cycle in the HDD 70a in the order of E, F, and G. The assignment algorithm stores the data units of one cycle in the HDD 70, and then stores data units of one cycle in the HDD 70a, and repeats it until all the data units are stored. This structure in which the data units (DY-i) are stored in the two HDDs 70 and 70a in a distributed manner can make it more difficult to reconstitute print data.

While the invention has been described in its preferred embodiments, it is to be understood that the invention is not limited to the specific embodiments and that various modifications, variations, and replacements by those skilled in the art can be made within the spirit and scope of the invention as hereinafter claimed, and it is intended to cover in the claims all such modifications as fall within the scope of the invention.

For example, when data units are stored in the two HDDs 70 and 70a shown in FIG. 9, a method may be used in which a specified number of data units are stored in the HDD 70 in a specified number of cycles, and then the remaining data units are stored in the HDD 70a in a specified number of cycles. Alternatively, one cycle may be a total of seven subregions A to G arranged at random in the HDDs 70 and 70a. It is needless to say that the number of HDDs for the image forming apparatus may be three or more.

Although the invention has been described for the case where the storage device for print data is an HDD, it is not limited to that; for example, the storage device may be a magneto-optic disk drive, a CD-RW drive, a DVD-RW drive, or a silicon drive. Preferably, a storage device with high writing speed and reading speed is used.

What is claimed is:

1. An image forming apparatus comprising:
a storage device having a data-storage region divided into multiple subregions for storing print data; and a file-management region for storing file-management information on the print data stored in the data-storage region; and
a data processing section that divides the print data to be stored in the storage device into multiple data units, stores the multiple data units into multiple subregions in a distributed manner, stores the file-management information on the multiple data units into the file-management region, and erases the file-management information stored in the file-management region after completion of print jobs.

2. The image forming apparatus according to claim 1, wherein
the data processing section compresses the data size of the print data to be stored in the storage device, and divides the compressed data into multiple data units.

3. The image forming apparatus according to claim 1, wherein
the storage device is a hard disk drive.

4. The image forming apparatus according to claim 3, wherein
the size of the data unit is equal to or larger than a sector and equal to or smaller than a cluster.

5. The image forming apparatus according to claim 1, wherein
the data processing section sets a data storage sequence for the multiple subregions, and repeatedly assigns the multiple data units to the multiple subregions in accordance with the data storage sequence.

6. The image forming apparatus according to claim 1, wherein
the data processing section changes the sequence of storing the multiple data units into the multiple subregions, depending on the number of the subregions.

7. The image forming apparatus according to claim 1, wherein
the print data includes multiple items of page data; and
the data processing section divides the print data into multiple data units for each item of page data.

8. The image forming apparatus according to claim 7, wherein
the data processing section sets a data storage sequence for the multiple subregions, and repeatedly assigns the multiple data units to the multiple subregions in accordance with the data storage sequence.

9. The image forming apparatus according to claim 8, wherein
the data processing section changes the data storage sequence from one page data to another.

10. The image forming apparatus according to claim 8, wherein
the data processing section changes the data storage sequence, depending on the number of the subregions.

11. The image forming apparatus according to claim 1, comprising
a plurality of the storage devices;
wherein the data processing section stores the multiple data units into the multiple subregions of the plurality of storage devices in a distributed manner.

12. An image forming apparatus comprising:
a scanner for reading the image of a document;
an image processing section for converting the image data read by the scanner to page data and storing the page data; and
a printer for printing the print data output from the image processing section on a specified medium;
wherein the image processing section includes:
a storage device having a data-storage region divided into multiple subregions for storing the page data; and a file-management region for storing file-management information on the page data stored in the data-storage region; and
a data processing section that divides the page data to be stored in the storage device into multiple data units, stores the multiple data units into multiple subregions in a distributed manner, stores the file-management information on the multiple data units in the file-management region, and erases the file-management information stored in the file-management region after completion of print jobs.

13. The image forming apparatus according to claim 12, further comprising:
a network interface for capturing print data from the exterior.

14. The image forming apparatus according to claim 12, further comprising:
a communication interface for performing facsimile communication with the exterior.
